(19) United States
(12) Patent Application Publication
(10) Pub. No.: US 2016/0234344 A1
(43) Pub. Date: Aug. 11, 2016

(54) MESSAGE LOG REMOVAL APPARATUS AND MESSAGE LOG REMOVAL METHOD

(71) Applicant: FUJITSU LIMITED, Kawasaki-shi (JP)

(72) Inventors: Junichi HIGUCHI, Kawasaki (JP); Yuji NOMURA, Kawasaki (JP)

(73) Assignee: FUJITSU LIMITED, Kawasaki-shi (JP)

(21) Appl. No.: 14/974,412

(22) Filed: Dec. 18, 2015

(30) Foreign Application Priority Data
Feb. 9, 2015 (JP) 2015-023377

(51) Int. Cl. H04L 29/06; H04L 29/08

(52) U.S. Cl. CPC H04L 67/42; H04L 69/329

(57) ABSTRACT

A message log removal apparatus includes a processor. The processor prepares, for each packet, a packet record including a reception time, a packet size, destination information, and source information. The processor prepares, on basis of the packet records, message records each corresponding to a pair of a request and a response. Each message record includes a first reception time, a second reception time, a request size, a response size, first source information, and first destination information. The request is constructed of first packets transmitted from the first transmission source to the first transmission destination. The response is constructed of second packets transmitted from the first transmission destination to the first transmission source. The processor removes a first message record from among the message records on basis of the request size, the response size, the first source information, and the first destination information included in the first message record.

### CROSS-REFERENCE TO RELATED APPLICATION

This application is based upon and claims the benefit of priority from the prior Japanese Patent Application No. 2015-023377, filed on Feb. 9, 2015, the entire contents of which are incorporated herein by reference.

### FIELD

The embodiment discussed herein is related to a message log removal apparatus and a message log removal method.

### BACKGROUND

Data is transmitted and received between communication devices through a communication network. Communication network equipment accumulates logs of the data transmission and reception and conducts an analysis of the logs.

Recently, as the amount of communications transmitted and received through the communication network increases, the accumulated amount of logs is increased and a time is required for the log analysis. Accordingly, for example, there are techniques for improving efficiency in the log analysis as described below.

As a first technique, there is a system analysis method for analyzing, by a computer, an operation form of a network in which a plurality of servers are connected. In the system analysis method, a message analyzing means analyzes the contents of a collected message and determines a message generation time, a processing type requested by the message, and whether the message is a request message or a response message. When a model generation instruction is input, a transaction model satisfying a restriction condition of a calling between servers is generated by a model generation means on the basis of a message set selected in accordance with a selection criterion based on a probability of a calling relationship between processes. When an analysis instruction is input, a processing state of a transaction is analyzed by an analysis means using a protocol log conforming to the transaction model.

As a second technique, there is an access log management method for a case of transmitting a request received from a client to a server and a response received from the server to the client in a relay device interconnected to both the client and the server through a network. In the access log management method, access logs are discriminated for each protocol used in an access from the client to the server. An access log having a type designated in advance as an access log to be compressed is compressed and an access log having a type designated in advance as an access log to be uncompressed is uncompressed.

Related techniques are disclosed in, for example, Japanese Laid-Open Patent Publication No. 2006-011683 and Japanese Laid-Open Patent Publication No. 2011-091465.

Various types of packets are transmitted and received in communications between the client and the server. Among the packets transmitted and received, packets unrelated to a request and a response thereto are included. These unrelated packets may include, for example, a packet for alive monitoring.

In the first technique, the messages unrelated to the request and the response are removed from a plurality of acquired communication packets in the measurement of the response time. The exclusion process may be implemented by analyzing an application layer of the message, but an extremely high burden is applied to the analysis. Further, an analysis of the application layer itself may be impossible in a case where a protocol specification of the communication message is not clear or the message is encrypted.

When the second technique is used, there is a problem that the log which is not designated in advance as a log to be compressed is not compressed even though the log is an unnecessary log.

### SUMMARY

According to an aspect of the present invention, provided is a message log removal apparatus including a storage device and a processor. The processor is configured to acquire data packets communicated between communication devices. The processor is configured to prepare a packet record for each of the data packets. The packet record includes a reception time, a packet size, destination information, and source information. The reception time indicates a time at which each of the data packets is received. The packet size indicates a size of each of the data packets. The destination information indicates a transmission destination of each of the data packets. The source information indicates a transmission source of each of the data packets. The processor is configured to store the prepared packet records in the storage device. The processor is configured to prepare message records on basis of the packet records stored in the storage device. Each of the message records corresponds to a pair of a request message and a response message. Each of the message records includes a first reception time, a second reception time, a first size indicating a size of the request message, a second size indicating a size of the response message, first source information indicating a first transmission source, and first destination information indicating a first transmission destination. The first reception time indicates a time at which the request message is received. The second reception time indicates a time at which the response message is received. The request message is constructed of first data packets transmitted from the first transmission source to the first transmission destination. The response message is constructed of second data packets transmitted from the first transmission destination to the first transmission source. The second data packets are received after the first data packets. The processor is configured to store the prepared message records in the storage device. The processor is configured to remove a first message record from among the message records stored in the storage device on basis of the first size, the second size, the first source information, and the first destination information included in the first message record.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary functional configuration of a message log removal apparatus according to an embodiment;

FIG. 2 is a sequence chart illustrating an exemplary communication sequence at a transport layer in communications between a client and a server;

FIG. 3 is a sequence chart illustrating an exemplary communication sequence in a case where a long polling is performed in communications between a client and a server;

FIG. 4 is a diagram illustrating an exemplary configuration of a message log removal system according to an embodiment;

FIG. 5 is a diagram illustrating an exemplary functional configuration of a message log removal apparatus;

FIG. 6 is a diagram illustrating a flow of a process performed by a message log removal apparatus;

FIG. 7 is a sequence chart for explaining packet handling at a transport layer and message handling at an application layer;

FIG. 8 is a table illustrating an exemplary configuration of a message log;

FIG. 9 is a table illustrating an exemplary configuration of connection management information;

FIG. 10 is a flowchart illustrating an exemplary process of preparing a message log on the basis of connection management information;

FIG. 11 is a flowchart illustrating an exemplary process of preparing a message log on the basis of connection management information;

FIG. 12 is a flowchart illustrating an exemplary process of preparing a message log on the basis of connection management information;

FIG. 13 is a sequence chart for explaining a process of extracting a removal condition;

FIG. 14 is a table illustrating an exemplary configuration of information to be removed;

FIG. 15 is a flowchart illustrating an exemplary process of determining a removal target;

FIG. 16 is a sequence chart for explaining a process of removing a pair to be removed from a message log;

FIG. 17 is a flowchart illustrating an example of a removal process;

FIG. 18 is a diagram illustrating an exemplary hardware configuration of a message log removal apparatus according to an embodiment, and

FIG. 19A and FIG. 19B are diagrams illustrating respective results of response time calculation in a comparative example and an embodiment.

### DESCRIPTION OF EMBODIMENT

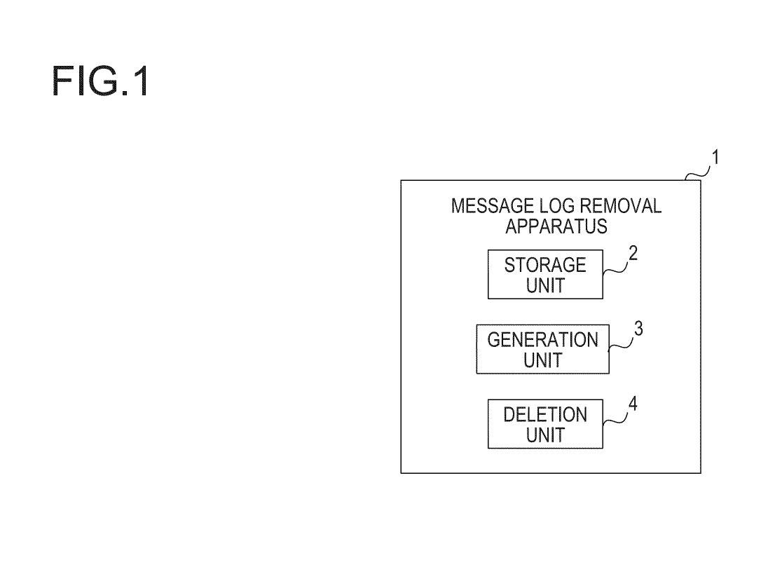

FIG. 1 is a diagram illustrating an exemplary functional configuration of a message log removal apparatus according to an embodiment. In FIG. 1, a message log removal apparatus 1 includes a storage unit 2, a generation unit 3, and a deletion unit 4.

The storage unit 2 stores first history information including a reception time, a size, transmission destination information, and transmission source information of a data packet in response to an acquisition of the data packet communicated between communication devices.

The generation unit 3 generates, on the basis of the first history information, second history information in which the reception time, the size, the transmission destination information, and the transmission source information of each of a first message and a second message are associated with each other for each pair of the first message and the second message. Here, the first message is a message constructed of data packets transmitted from a transmission source to a transmission destination. The second message is a message constructed of data packets acquired subsequently to the first message, and is transmitted from the transmission destination to the transmission source.

The deletion unit 4 deletes, from the second history information, one of pairs of the first and second messages having identical transmission source information and identical transmission destination information on the basis of the sizes of the first and second messages of the pairs of the first and second messages.

The message log removal apparatus 1 according to the embodiment may discriminate, by analyzing packets at the transport layer, a log of a packet unrelated to a measurement of a response time. That is, the message log removal apparatus 1 may discriminate a message log unrelated to the measurement of the response time without analyzing the packets at the application layer. Accordingly, the message log removal apparatus 1 may efficiently remove the message log unrelated to the measurement of the response time.

Further, the deletion unit 4 deletes, from the second history information, one of pairs of the first and second messages having identical transmission source information and identical transmission destination information on the basis of the sizes of the first message and second message and a time interval between the reception time of the first message and the reception time of the second message. Accordingly, the accuracy of discriminating the message log unrelated to the measurement of the response time may be improved.

The deletion unit 4 removes the message log unrelated to the measurement of the response time as described below. That is, the deletion unit 4, first of all, discriminates pairs of the first and second messages for which the time interval between the reception time of the first message and the reception time of the second message is equal to or greater than a predetermined threshold value among the pairs of the first and second messages of the second history information. Next, the deletion unit 4 identifies groups each including a predetermined number or more pairs of the first and second messages satisfying the following four conditions among the discriminated pairs of the first and second messages. (1) The transmission source information and the transmission destination information of the pairs of the first and second messages are identical, respectively. (2) The difference in size between the first messages is within a predetermined threshold value. (3) The difference in size between the second messages is within a predetermined threshold value. (4) A standard deviation of the time intervals between the reception time of the first message and the reception time of the second message is within a predetermined threshold value. The deletion unit 4 deletes, from the second history information, one of the pairs of the first and second messages included in the identified group on the basis of the sizes of the first and second messages. Accordingly, an accuracy of discriminating the message log unrelated to the measurement of the response time may be improved.

Hereinafter, details of the message log removal apparatus according to the embodiment will be described. First of all, descriptions will be made on a method of calculating a response time in a comparative example in order to explain an effect of the embodiment. In the following descriptions, a communication direction of a packet or a message directed from the client to the server may be referred to as an “upstream”, and a communication direction of a packet or a message directed from the server to the client may be referred to as a “downstream”. It is assumed that a “message” is a minimum unit of data transmitted and received by a plurality of equipment in accordance with a predetermined protocol at the application layer.

In the method of calculating a response time in the comparative example, a response time interval is calculated on the basis of a time interval between an acquisition of a communication packet in an upstream direction and an acquisition of a communication packet in a downstream direction within the same connection.

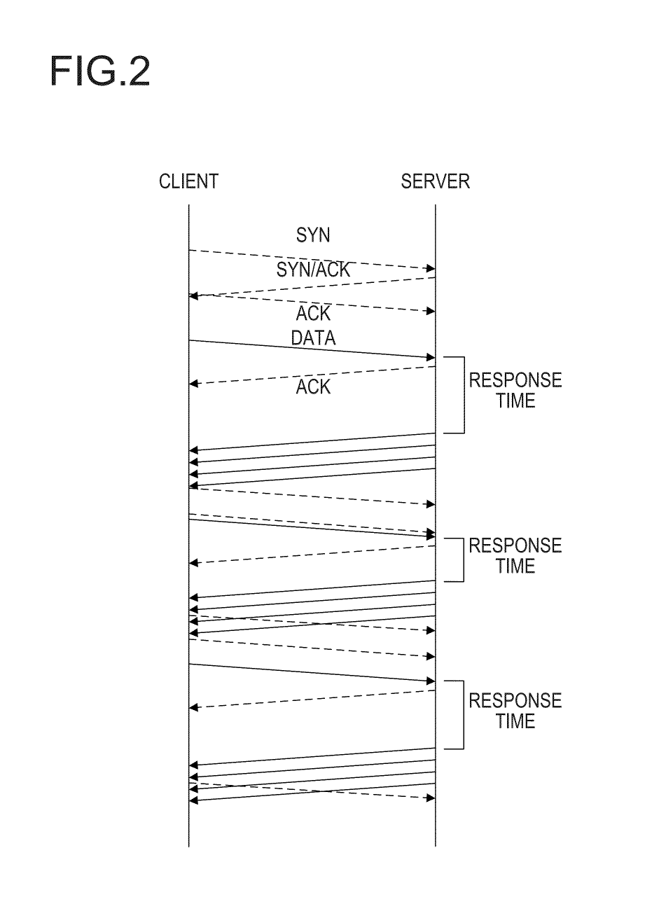

FIG. 2 is a sequence chart illustrating an exemplary communication sequence at the transport layer in communications between a client and a server. In FIG. 2, a communication control packet such as, for example, a synchronize packet (SYN), an acknowledgement packet (ACK), and a finish packet (FIN) is represented by a dotted line. A data packet which includes data to be transmitted in a transmission control protocol (TCP) payload is represented by a solid line.

In the comparative example, when the communication direction of a data packet is changed from the upstream to the downstream, the response time is calculated on the basis of the acquisition times of the upstream packet and the downstream packet. Specifically, in the relay device, the time interval between the acquisition time of the upstream data packet and the acquisition time of the downstream data packet is calculated as the response time.

In the comparative example, it is assumed that processing is performed in the server or a subsequent server group from the reception of the request to the reply of the response. However, for example, in a case where a technique such as a long polling is used, no processing may be performed in the server from the reception of the request to the first response.

The long polling is a technique to transmit data unilaterally from a server side in a real time. The server having received a request keeps the connection alive without replying a response until data to be sent from the server side is prepared. When a time-out of the connection occurs, the server is controlled to be connected again immediately. Alternatively, the server transmits dummy data to the client at regular time intervals such that the time-out of the connection does not occur. When some kind of event occurs in the server, the server replies a response.

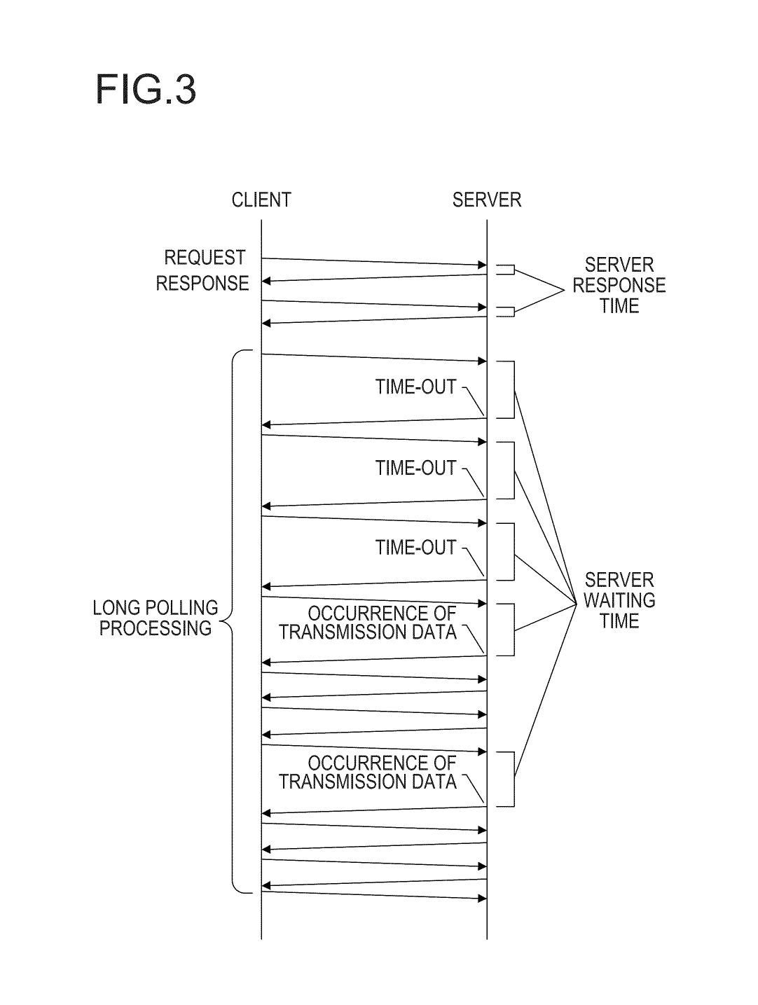

FIG. 3 is a sequence chart illustrating an exemplary communication sequence in a case where a long polling is performed in communications between the client and the server. FIG. 3 illustrates an example in which the time-out occurs for a plurality of times until the transmission data to be transmitted from the server is prepared in the processing of the long polling. When the time-out occurs, a packet is replied from the server to the client and the client which has received the packet immediately transmits a packet to the server such that the connection is being kept alive. However, in the server, a time interval from the reception of the first request to the preparation of the transmission data is a waiting time.

In the comparative example, it is assumed that a case where the long polling processing occurs. As in the comparative example, when the response time is calculated on the basis of the acquisition time of the upstream packet and the acquisition time of the downstream packet, a time interval of the waiting time during which processing is not actually performed in the server is calculated as a response time. For example, a time between the request and the response caused by the occurrence of the time-out is calculated as a response time. Accordingly, in the comparative example, the accuracy of calculating the response time is reduced when the long polling processing occurs.

In the embodiment, in order to prevent the reduction of the accuracy of calculating the response time even when the long polling has occurred, processing of discriminating a pair of request and response including a response caused by the occurrence of the time-out among the pairs of the request and response is performed. Then, the discriminated pair of the request and response is excluded from the response time calculation. Accordingly, in the embodiment, the response time may be calculated more accurately.

### Embodiment

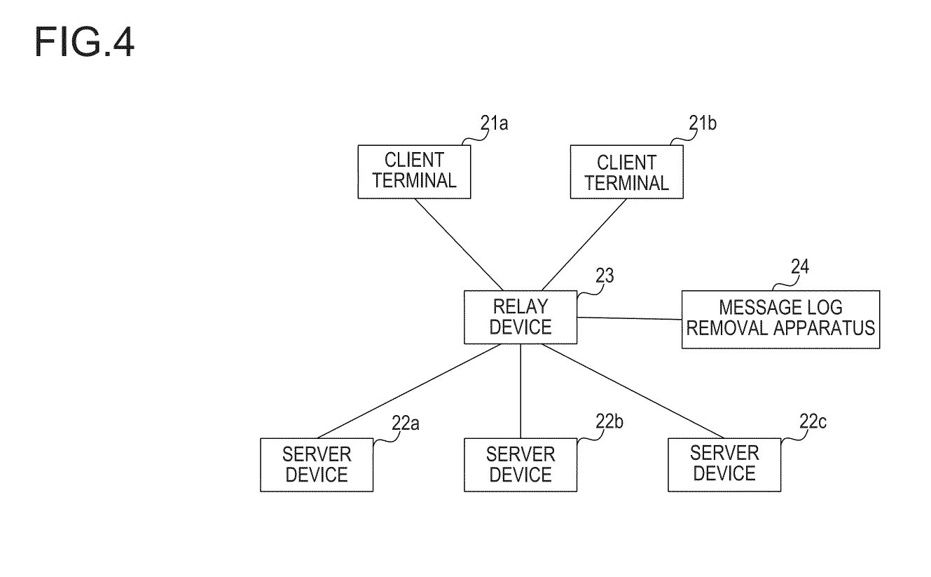

FIG. 4 is a diagram illustrating an exemplary configuration of a message log removal system according to the embodiment. In FIG. 4, the message log removal system includes one or more client terminals 21 (21a, 21b), one or more server devices 22 (22a, 22b, 22c), a relay device 23, and a message log removal apparatus 24. The client terminals 21 are connected to the server devices 22 through the relay device 23. The relay device 23 is connected to the message log removal apparatus 24.

The client terminal 21 transmits a request to the server device 22. The client terminal 21 receives a response to the request.

The server device 22 receives a request from the client terminal 21. The server device 22 replies a response to the request.

The relay device 23 relays a packet transmitted and received between the client terminal 21 and the server device 22. The relay device 23 captures the packet transmitted and received between the client terminal 21 and the server device 22. The relay device 23 replicates the captured packet and transmits the replicated packet to the message log removal apparatus 24. The relay device 23 is, for example, a tap, a repeater, a hub, a switch, or the like. For example, a mirror port of the relay device 23 may be connected to the message log removal apparatus 24 to transmit the packet from the mirror port to the message log removal apparatus 24.

The message log removal apparatus 24 acquires, from the relay device 23, a packet transmitted and received between the client terminal 21 and the server device 22. The message log removal apparatus 24 removes, using the acquired packets, messages unrelated to the measurement of the response time.

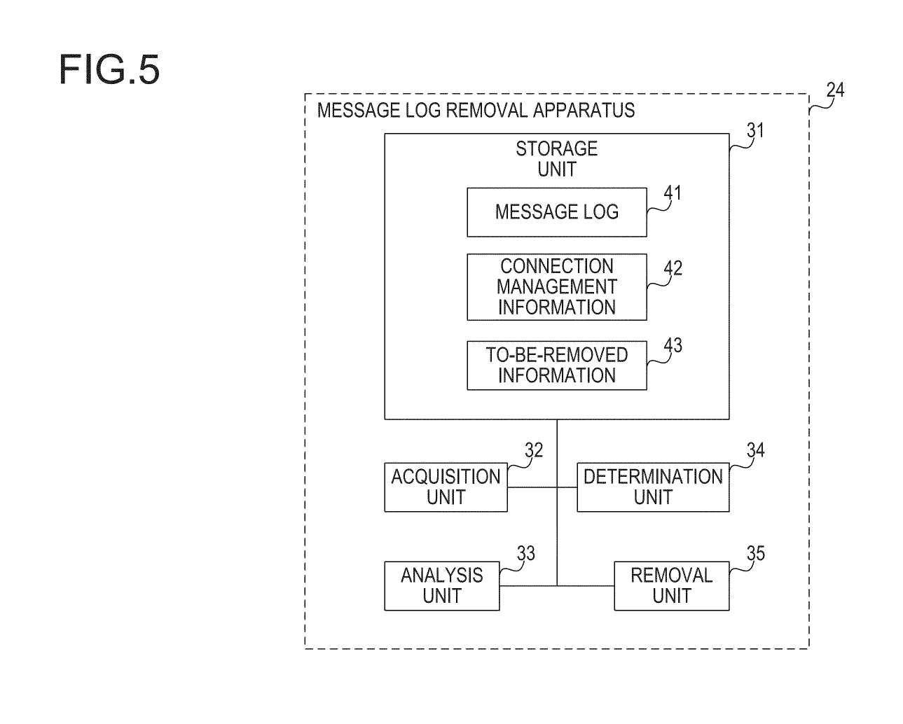

FIG. 5 is a diagram illustrating an exemplary functional configuration of the message log removal apparatus 24. The message log removal apparatus 24 includes a storage unit 31, an acquisition unit 32, an analysis unit 33, a determination unit 34, and a removal unit 35.

The message log removal apparatus 24 is an example of the message log removal apparatus 1. The storage unit 31 is an example of the storage unit 2. The analysis unit 33 is an example of the generation unit 3. The removal unit 35 is an example of the deletion unit 4.

The storage unit 31 stores therein a message log 41, connection management information 42, and to-be-removed information 43. The message log 41 is an example of the second history information. The connection management information 42 is an example of the first history information.

The message log 41 is information including information in which the size, the response time, and the identification information of the transmission source and the transmission destination are associated with each other for each pair of the request and response messages. The connection management information 42 is a temporary file for preparing the message log 41 on the basis of the acquired packets. The to-be-removed information 43 is information indicating a condition (hereinafter, described as a removal condition) for removing a pair of the request and response messages. That is, the to-be-removed information 43 indicates information unrelated to the measurement of the response time among the message log 41. Details of the respective information will be described later.

The acquisition unit 32 acquires a packet from the relay device 23. The acquisition unit 32 may store the acquired packet in association with an acquisition time, for example, in a predetermined storage area of a storage unit.

The analysis unit 33 analyzes the packet acquired by the acquisition unit 32 at the transport layer or a lower layer and performs the preparation of the message log 41. In the preparation of the message log 41, the analysis unit 33 uses the connection management information 42 as a temporary file. Details of the process of preparing the message log 41 will be described later.

The determination unit 34 extracts a removal condition on the basis of the pairs of the request and response messages recorded in the message log 41. The determination unit 34 records the extracted removal condition in the to-be-removed information 43. Details of the process of extracting the removal condition will be described later

The removal unit 35 removes pairs of the request and response messages to be removed from the message log 41 on the basis of the to-be-removed information 43. Details of the removal process will be described later.

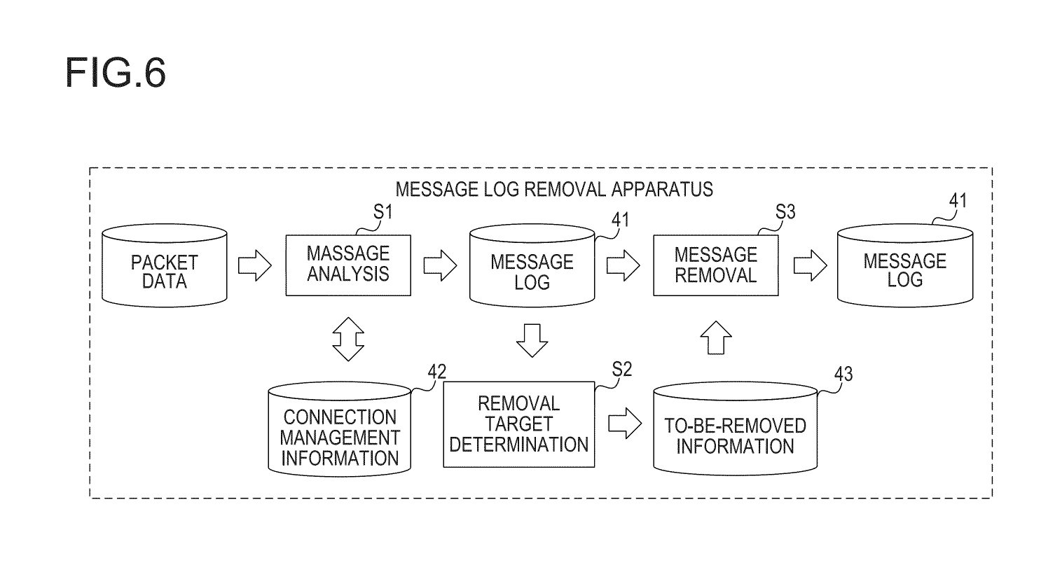

FIG. 6 is a diagram illustrating a flow of a process performed by the message log removal apparatus 24. In FIG. 6, first of all, the acquisition unit 32 acquires a packet. The acquisition unit 32 may record the acquired packet in a predetermined storage area as packet data in association with an acquisition time of the packet. Next, the analysis unit 33 performs a message analysis of the packet to prepare the message log 41 (S1). The connection management information 42 is used in preparation of the message log 41. Next, the determination unit 34 performs determination of a removal target on the basis of the message log 41 so as to prepare the to-be-removed information 43 (S2). The removal unit 35 removes messages to be removed from the message log 41 on the basis of the to-be-removed information 43 so as to update the message log 41 (S3).

Hereinafter, details of processing performed by each unit will be sequentially described. First of all, descriptions will be made on a message analysis (S1 of FIG. 6) of packets performed by the analysis unit 33.

The analysis unit 33 prepares the message log 41 on the basis of the packet data acquired by the acquisition unit 32. As described above, the message log 41 is information including information in which the size, the response time, and the identification information of the transmission source and the transmission destination are associated with each other for each pair of the request and response messages.

Specifically, the analysis unit 33 analyzes the packets at the transport layer. As a result of the analysis, the analysis unit 33 calculates the size and the response time for each pair of the request and response messages at the application layer. The analysis unit 33 records the calculated information in the message log 41. In the embodiment, the analysis by the analysis unit 33 is performed at the transport layer, but the pair of the request and response messages recorded in the message log 41 is a pair of the request and response messages at the application layer.

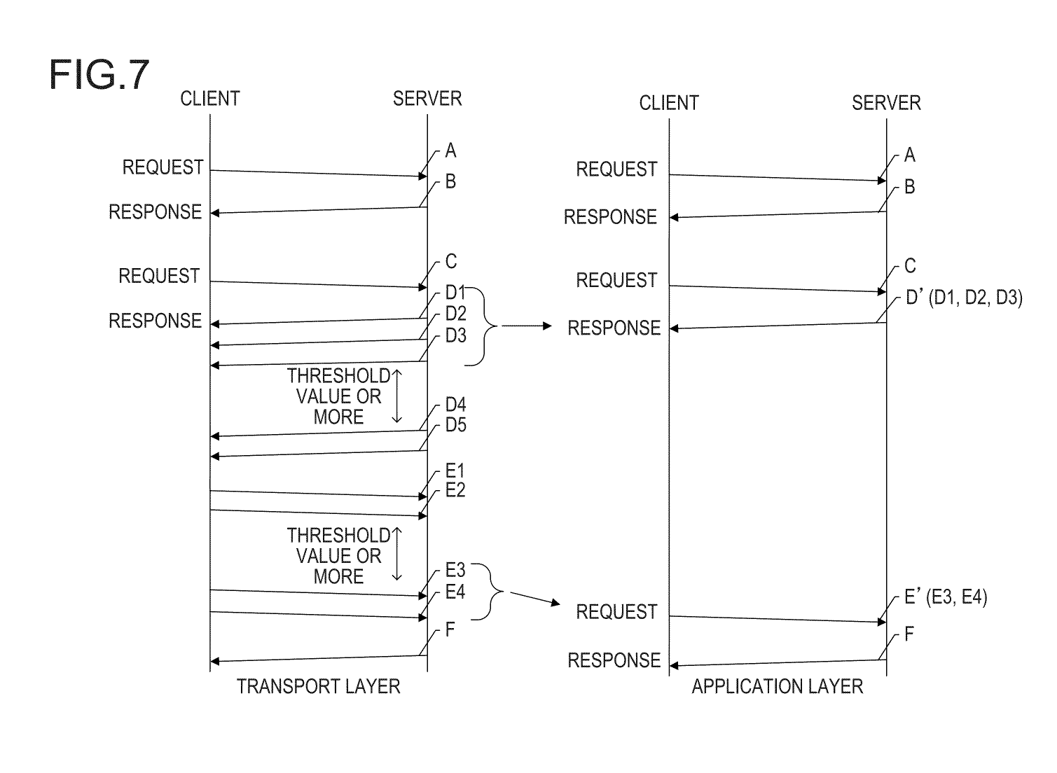

Here, descriptions will be made on packet handling at the transport layer and message handling at the application layer with reference to FIG. 7.

FIG. 7 is a sequence chart for explaining packet handling at the transport layer and message handling at the application layer. The left side of FIG. 7 illustrates an exemplary communication sequence of packets at the transport layer. The right side of FIG. 7 illustrates an exemplary communication sequence of messages at the application layer.

Here, the request indicates a packet or a message transmitted from a client to a server. The response indicates a packet or a message transmitted from the server to the client. It is assumed that the response corresponds to the request received latest by the server in the same connection.

When the left side of FIG. 7 is compared with the right side of FIG. 7, several request packets and several response packets in the left side of FIG. 7 are aggregated as a single request message and a single response message in the right side of FIG. 7. The aggregated request packets are consecutive request packets. However, when a time interval between a pair of successive request packets is equal to or greater than a predetermined threshold value, consecutive request packets transmitted after the time interval are aggregated. Here, the “consecutive request packets” refer to request packets having no response packet between each pair of successive request packets. The aggregated response packets are also consecutive response packets. However, when a time interval between a pair of successive request packets is equal to or greater than a predetermined threshold value, the consecutive response packets transmitted before the time interval are aggregated. Here, the “consecutive response packets” refer to response packets having no request packet between each pair of successive response packets.

In the left side of FIG. 7, response packets D1, D2, D3, D4, and D5 are consecutive. Further, a time interval between the response packets D3 and D4 is equal to or greater than a predetermined threshold value. In this case, the response packets D1, D2, and D3 are aggregated as a response message D′ in the right side of FIG. 7. Further, request packets E1, E2, E3, and E4 are consecutive in the left side of FIG. 7. A time interval between the request packets E2 and E3 is equal to or greater than a predetermined threshold value. In this case, the request packets E3 and E4 are aggregated as a response message E′ in the right side of FIG. 7.

The size of the aggregated request message is a sum of the sizes of the request packets before the aggregation. Further, it is assumed that the acquisition time of the aggregated request message is the acquisition time of the request packet which is acquired latest among the request packets before the aggregation. For example, the size of the request message E′ in the right side of FIG. 7 is a sum of the sizes of the request packets E3 and E4 in the left side of FIG. 7. Further, the acquisition time of the request message E′ is identical to the acquisition time of the request packet E4.

The size of the aggregated response message is a sum of the sizes of the response packets before the aggregation. Further, it is assumed that the acquisition time of the aggregated response message is the acquisition time of the response packet which is acquired earliest among the response packets before the aggregation. For example, the size of the response message D′ in the right side of FIG. 7 is a sum of the sizes of the response packets D1, D2, and D3 in the left side of FIG. 7. Further, the acquisition time of the response message D′ is identical to the acquisition time of the response packet D1.

The analysis unit 33 analyzes the packets at the transport layer and collects information for each pair of the request and response messages at the application layer on the basis of the communication direction and the time interval of the packets. The analysis unit 33 outputs the information in which the size, the response time, and the identification information of the client and the server are associated with each other to the message log 41 for each pair of the request and response messages. In a case of the example of FIG. 7, information in which the size, the response time, and identification information of the client and the server are associated with each other is output to the message log 41 for each of the pair (A, B), the pair (C, D′), and the pair (E′, F).

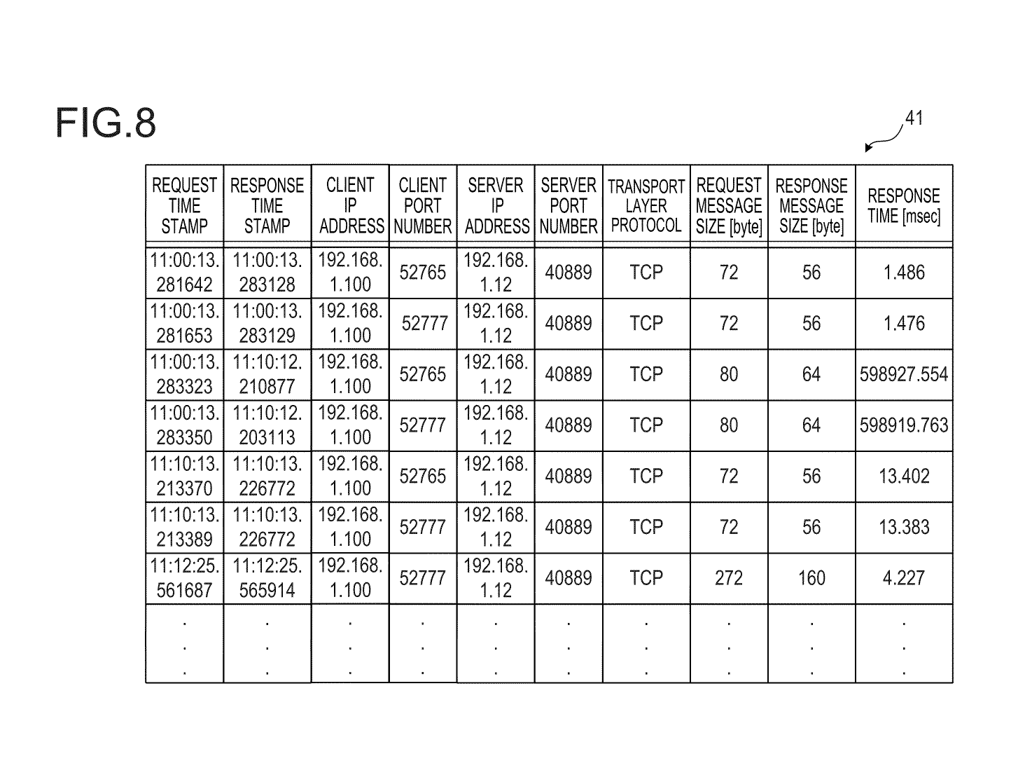

FIG. 8 is a table illustrating an exemplary configuration of the message log 41. In FIG. 8, the message log 41 includes data items for a “request time stamp”, a “response time stamp”, a “client Internet Protocol (IP) address”, a “client port number”, a “server IP address”, and a “server port number”. Further, the message log 41 includes data items for a “transport layer protocol”, a “request message size”, a “response message size”, and a “response time”. The data items are associated with each other for each record (row).

Each record of the message log 41 corresponds to each of the pairs of the request and response messages at the application layer.

The “request time stamp” is information indicating the acquisition time of the request message. The “response time stamp” is information indicating the acquisition time of the response message. The “client IP address” is information indicating an IP address of the client terminal 21 which has transmitted the request message. The “client port number” is information indicating a port number of the client terminal 21 which has transmitted the request message. The “server IP address” is information indicating an IP address of the server which has transmitted the response message. The “server port number” is information indicating a port number of the server which has transmitted the response message. The “transport layer protocol” is information indicating a type of a transport layer protocol used in communication between the pair of the request and response messages. The “request message size” is information indicating the size of the request message. The “response message size” is information indicating the size of the response message. The “response time” is information indicating a time interval between the time at which the request message is acquired and the time at which the response message is acquired by the acquisition unit 32. That is, the value of the “response time” is equal to the difference between the “response time stamp” and the “request time stamp”.

The connection is uniquely identified by a combination of the data items of the “client IP address”, the “client port number”, the “server IP address”, the “server port number”, and the “transport layer protocol”. In the following descriptions, the combination of the data items may be referred to as “connection information”.

The analysis unit 33 prepares the message log 41 as described above on the basis of the packets acquired by the acquisition unit 32. Hereinafter, the process of preparing the message log 41 will be described in detail. Here, the analysis unit 33 determines, as the server, a receiving side of the first SYN packet or a Well-Known port side when the connection is established.

The analysis unit 33, first of all, analyzes the packets acquired by the acquisition unit 32 at the transport layer or a lower layer. Specifically, the analysis unit 33 analyzes the TCP/IP header of each packet. As a result of the analysis, the analysis unit 33 acquires connection information of a connection through which the packet is communicated, the communication direction of the packet, and the size of the packet. The connection information includes information indicating an IP address and a port number of each of the client and the server. The connection information also includes information indicating a type of a transport layer protocol used in communication. The communication direction is information indicating whether a reception destination of the packet is the client or the server. The analysis unit 33 stores the connection information of the packet, the communication direction of the packet, and the size of the packet acquired by the analysis of the connection management information 42, together with the acquisition time of the packet. As described above, the connection management information 42 is a temporary file for preparing the message log 41.

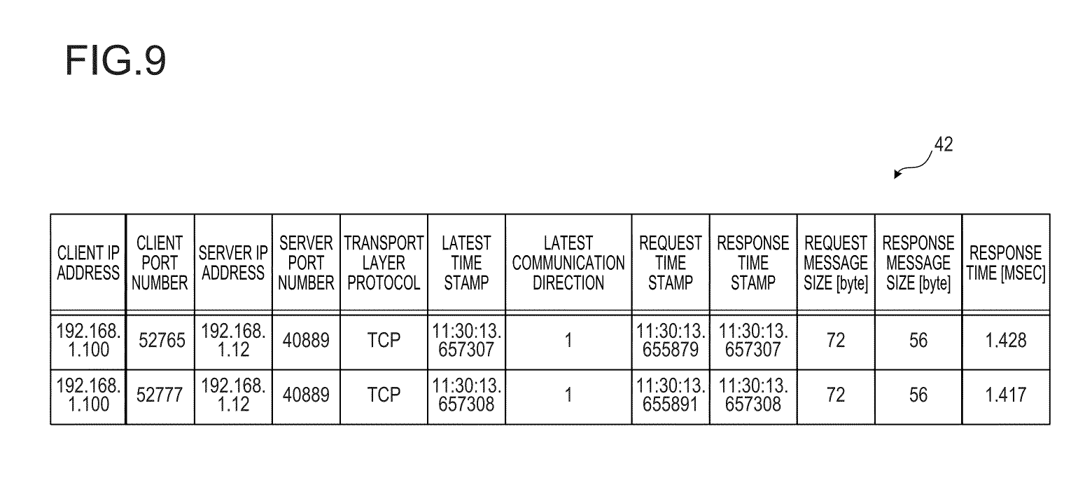

FIG. 9 is a table illustrating an exemplary configuration of the connection management information 42. In FIG. 9, the connection management information 42 includes data items for a “client IP address”, a “client port number”, a “server IP address”, a “server port number”, a “transport layer protocol”, and a “latest time stamp”. Further, the connection management information 42 includes data items for a “latest communication direction”, a “request time stamp”, a “response time stamp”, a “request message size”, a “response message size”, and a “response time”. The data items are associated with each other for each record (row). Each record of the connection management information 42 corresponds to each connection.

The “client IP address”, the “client port number”, the “server IP address”, the “server port number”, and the “transport layer protocol” in the connection management information 42 are similar to the corresponding data items of the message log 41 illustrated in FIG. 8. The “request time stamp”, the “response time stamp”, the “request message size”, the “response message size”, and the “response time” in the connection management information 42 are also similar to the corresponding data items of the message log 41 illustrated in FIG. 8. The “latest time stamp” is information indicating the acquisition time of a packet (request packet or response packet) next preceding the current packet in packet communications through the same connection. The “latest communication direction” is information indicating the communication direction of the packet (request packet or response packet) next preceding the current packet in packet communications through the same connection.

Next, the analysis unit 33 detects a change in the communication direction of a packet on the basis of the connection management information 42. Specifically, the analysis unit 33 refers to the “latest communication direction” in the connection management information 42 so as to detect the change in the communication direction. With this, the analysis unit 33 recognizes a correspondence relationship between the request and the response. When two successive packets have the same communication direction, the analysis unit 33 determines whether the time interval between the two successive packets is a threshold value or more. Specifically, the analysis unit 33 determines whether the time interval between the two successive packets is the threshold value or more by referring to the “latest time stamp” in the connection management information 42. Accordingly, the analysis unit 33 may appropriately aggregate the packets and convert the packets into information regarding a message.

Then, the analysis unit 33 outputs, to the message log 41, the connection information, the size of the packet, the acquisition time of the packet, and the response time in association with each other for each pair of the request and response messages at the application layer.

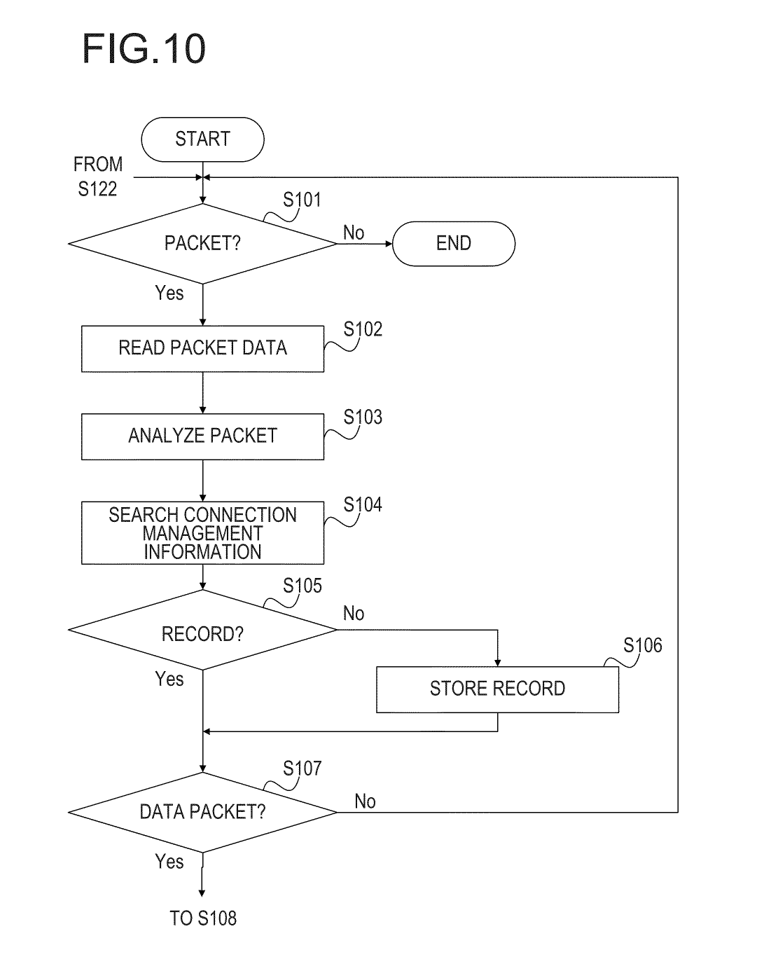

FIG. 10 to FIG. 12 are flowcharts illustrating an exemplary process of preparing the message log 41 on the basis of the connection management information 42.

In FIG. 10, first of all, the analysis unit 33 determines whether a packet to be analyzed exists (S101). When it is determined that a packet to be analyzed does not exist (“NO” at S101), the preparation process is ended.

When it is determined that a packet to be analyzed exists (“YES” at S101), the analysis unit 33 reads the packet data (S102). The packet read at S102 is referred to as a target packet in the descriptions of FIG. 10 to FIG. 12.

Next, the analysis unit 33 analyzes the target packet at the transport layer or a lower layer (S103). As a result of the analysis, the analysis unit 33 acquires connection information of a connection through which the target packet is communicated, a communication direction of the target packet, a size of the target packet, and an acquisition time of the target packet. The analysis unit 33 may acquire the acquisition time of the target packet from the acquisition unit 32.

Next, the analysis unit 33 searches the connection management information 42 (S104) and determines whether a record corresponding to the target packet exists in the connection management information 42 (S105). Specifically, the analysis unit 33 determines whether a record of which the connection information is identical to the connection information of the target packet acquired at S103 exists in the management information 42. The connection information includes the data items for the “client IP address”, the “client port number”, the “server IP address”, the “server port number”, and the “transport layer protocol”. When a record of which these data items are identical to the connection information of the target packet exists, the analysis unit 33 determines that a record corresponding to the connection of the target packet exists in the connection management information 42.

When it is determined that a record corresponding to the connection of the target packet does not exist in the connection management information 42 (“NO” at S105), the analysis unit 33 stores the connection information of the target packet in the connection management information 42 (S106). Specifically, the analysis unit 33 newly prepares a record corresponding to the target packet in the connection management information 42. Then, the analysis unit 33 stores the connection information of the target packet as the connection information of the prepared record. Next, the preparation process goes to S107.

When it is determined that a record corresponding to the connection of the target packet exists in the connection management information 42 (“YES” at S105), the analysis unit 33 determines whether the target packet is a data packet (S107). When it is determined that the target packet is not a data packet (“NO” at S107), the preparation process goes back to S101.

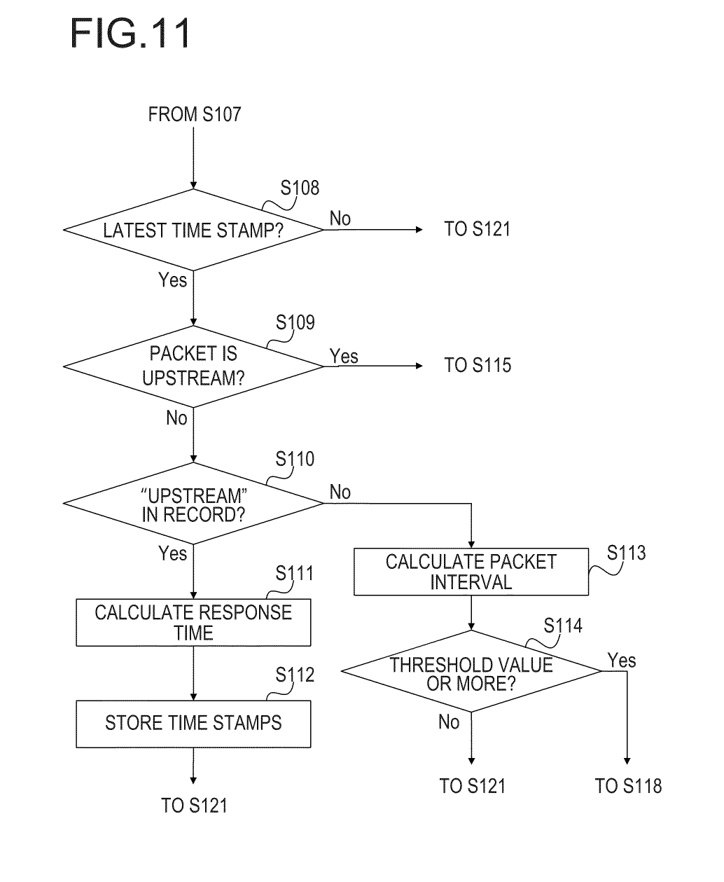

When it is determined that the target packet is a data packet (“YES” at S107), the preparation process goes to S108 of FIG. 11.

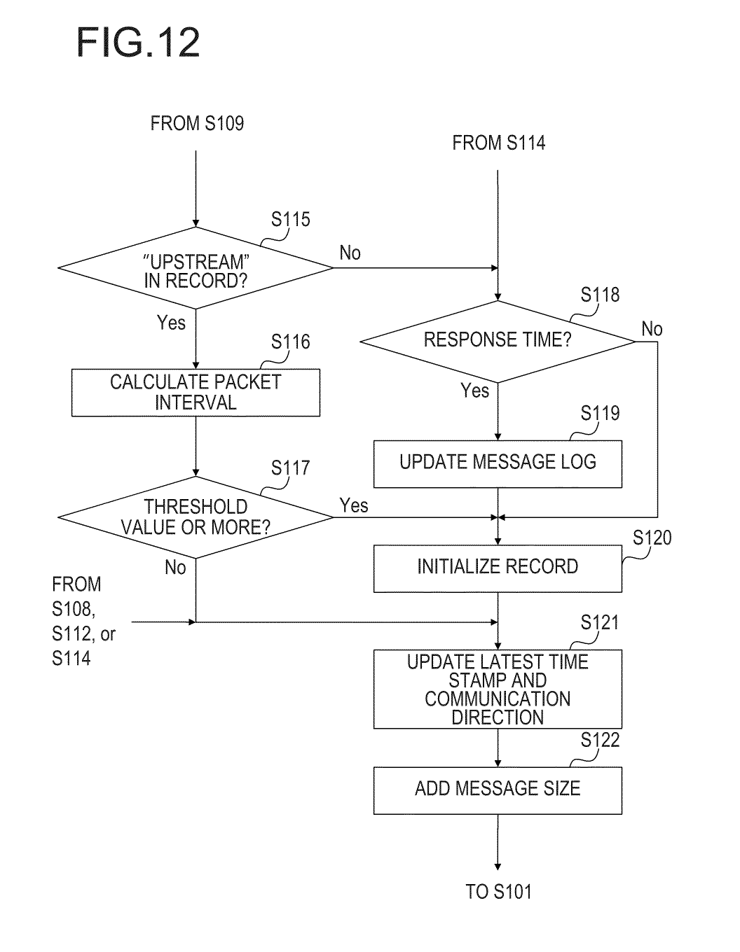

At S108 of FIG. 11, the analysis unit 33 determines whether some value has been stored in the “latest time stamp” of the record (hereinafter, referred to as a target record) corresponding to the target packet among the connection management information 42 (S108). When it is determined that no value has been stored in the “latest time stamp” of the target record (“NO” at S108), the preparation process goes to S121 of FIG. 12.

At S121 of FIG. 12, the analysis unit 33 stores information indicating the acquisition time and the communication direction of the target packet in the “latest time stamp” and the “communication direction” of the target record, respectively (S121).

Next, the analysis unit 33 stores the size of the target packet in the target record (S122). Specifically, when the communication direction of the target packet is the upstream, the size of the target packet is added to the value of the “request message size” of the target record. When the communication direction of the target packet is the downstream, the size of the target packet is added to the value of the “response message size” of the target record. Then, the preparation process goes back to S101 again.

Descriptions will be referred back to S108 of FIG. 11. When it is determined that some value has been stored in the “latest time stamp” of the target record (“YES” at S108), it is determined whether the communication direction of the target packet is the upstream (S109). When it is determined that the communication direction is the downstream (“NO” at S109), the analysis unit 33 determines whether the “communication direction” of the target record is the upstream (S110). When it is determined that the communication direction of the target record is the upstream (“YES” at S110), the analysis unit 33 calculates a response time and stores the calculated response time in the target record (S111). Specifically, the analysis unit 33 calculates a difference between the acquisition time of the target packet and the “latest time stamp” of the target record as the response time. Then, the analysis unit 33 stores the calculated response time in the “response time” of the target record.

Next, the analysis unit 33 stores values in the “request time stamp” and the “response time stamp” of the target record (S112). Specifically, the analysis unit 33 stores the value of the “latest time stamp” of the target record in the “request time stamp”, and the acquisition time of the target packet in the “response time stamp” of the target record. Next, the preparation process goes to S121 of FIG. 12.

Descriptions will be referred back to S110 of FIG. 11. When it is determined that the “communication direction” of the target record is the downstream (“NO” at S110), the analysis unit 33 calculates a time interval of response packets (S113). Specifically, the analysis unit 33 calculates the difference between the acquisition time of the target packet and the “latest time stamp” of the target record as the time interval of response packets.

Next, the analysis unit 33 determines whether the time interval of response packets calculated at S113 is equal to or greater than a predetermined threshold value (S114). When it is determined that the time interval of response packets is less than the predetermined threshold value (“NO” at S114), the preparation process goes to S121 of FIG. 12. When it is determined that the time interval of response packets is equal to or greater than the predetermined threshold value (“YES” at S114), the preparation process goes to S118 of FIG. 12.

At S118 of FIG. 12, the analysis unit 33 determines whether some value is stored in the “response time” of the target record (S118). When it is determined that no value is stored in the “response time” of the target record (“NO” at S118), the preparation process goes to S120.

When it is determined that some value is stored in the “response time” of the target record (“YES” at S118), the analysis unit 33 outputs the information of the target record to the message log 41 (S119). Specifically, the analysis unit 33 prepares a new record in the message log 41 and stores the value of the corresponding data item (the data item having the same name) of the target record in each data item of the prepared record.

Next, the analysis unit 33 initializes the target record (S120). Specifically, the analysis unit 33 erases the values of the “request time stamp”, the “response time stamp”, the “request message size”, and the “response message size” of the target record. Then, the preparation process goes to S121.

Descriptions will be referred back to S109 of FIG. 11. When it is determined that the communication direction is the upstream (“YES” at S109), the preparation process goes to S115 of FIG. 12.

At S115 of FIG. 12, the analysis unit 33 determines whether the “communication direction” of the target record is the upstream (S115). When it is determined that the “communication direction” is the downstream (“NO” at S115), the preparation process goes to S118.

When it is determined that the “communication direction” is the upstream (“YES” at S115), the analysis unit 33 calculates the time interval of request packets (S116). Specifically, the analysis unit 33 calculates the difference between the acquisition time of the target packet and the “latest time stamp” of the target record as the time interval of request packets.

Next, the analysis unit 33 determines whether the time interval of request packets calculated at S116 is equal to or greater than a predetermined threshold value (S117). When it is determined that the time interval of request packets is less than the predetermined threshold value (“NO” at S117), the preparation process goes to S121. When it is determined that the time interval of request packets is equal to or greater than the predetermined threshold value (“YES” at S117), the preparation process goes to S120.

In the foregoing, the process of preparing the message log 41 on the basis of the connection management information 42 has been described.

Next, descriptions will be made on the determination of a removal target (S2 of FIG. 6) performed by the determination unit 34. The determination unit 34 extracts, from the message log 41, a removal condition for removing a pair of the request and response messages. Then, the determination unit 34 records the extracted removal condition in the to-be-removed information 43. In the determination of a removal target, it is assumed that the message log 41 is prepared for messages acquired during a predetermined period of time.

Specifically, the determination unit 34, first of all, extracts pairs of the request and response messages for which the response time is a predetermined threshold value Δtₜₕ or more from the message log 41. Then, among the extracted pairs of the request and response messages, the determination unit 34 identifies groups each including pairs of the request and response messages that satisfy four determination conditions. The four determination conditions are as follows. That is, (1) whether values of the data items for identifying a handling unit are the same, (2) whether the request sizes are the same, (3) whether the response sizes are the same, and (4) whether the pairs of the request and response messages are consecutive. The determination conditions are used in a comparison between a plurality of pairs of the request and response messages.

Here, the handling unit in the determination condition (1) is messages communicated in a single connection or messages communicated in plural connections. Specifically, when the handling unit is messages communicated in a single connection, the determination condition (1) corresponds to the following. That is, the determination condition (1) corresponds to a condition in which all the values of the “client IP address”, the “client port number”, the “server IP address”, the “server port number”, and the “transport layer protocol” of the message log 41 are identical. When the handling unit is messages communicated in plural connections, the determination condition (1) corresponds to a condition in which all the values of the “client IP address”, the “server IP address”, the “server port number”, and the “transport layer protocol” of the message log 41 are identical.

The consecutive pairs in the determination condition (4) indicate pairs of the request and response messages having been consecutively communicated in time series. Specifically, the consecutive pairs of the request and response messages are such that no other record exists between the records of the consecutive pairs when the records of the message log 41 for a handling unit are arranged in an ascending order of the “request time stamp”. pairs of the request and response messages that

A slight difference may be permitted for the determination conditions (2) and (3) regarding the size of the request message and the response message. That is, when the difference in the size between the pairs of the request and response messages is less than a predetermined threshold value, the sizes of the pairs of the request and response messages may be regarded as identical. Further, the determination condition (4) is not necessarily included in the determination conditions.

When the identification of the groups is completed, the determination unit 34 determines whether the number of the pairs of the request and response messages included in each of the identified groups is equal to or greater than a predetermined threshold value t1. When it is determined that the number of the pairs of the request and response messages included in a identified group is equal to or greater than the predetermined threshold value t1, the determination unit 34 determines whether a standard deviation of the response time of the pairs of the request and response messages included in the group is equal to or less than a predetermined threshold value σₜₕ. When it is determined that the standard deviation of the response time of the pairs of the request and response messages included in the group is equal to or less than the predetermined threshold value σₜₕ, the determination unit 34 extracts a removal condition for the group. The removal condition for the group includes the data items for identifying the handling unit, the size of the request message, and the size of the response message. Here, the determination unit 34 may extract the removal condition for the group when a part of the group satisfies the conditions regarding the number of the pairs and the standard deviation of the response time, that is, the number of the pairs of the request and response messages included in the part of the group is equal to or greater than the predetermined threshold value t1 and the standard deviation of the response time of the pairs of the request and response messages included in the part of the group is equal to or less than the predetermined threshold value σₜₕ. For example, when it is assumed that the message pairs included in the group are (A, B, C, D) and the threshold value t1 is “3”, if the standard deviation of any one of the message pairs among the following combinations is equal to or less than the threshold value σₜₕ, the data item for identifying the handling unit, the size of the request message, and the size of the response message may be extracted as the removal condition. The combinations are (A, B, C), (A, B, D), (A, C, D), (B, C, D), and (A, B, C, D).

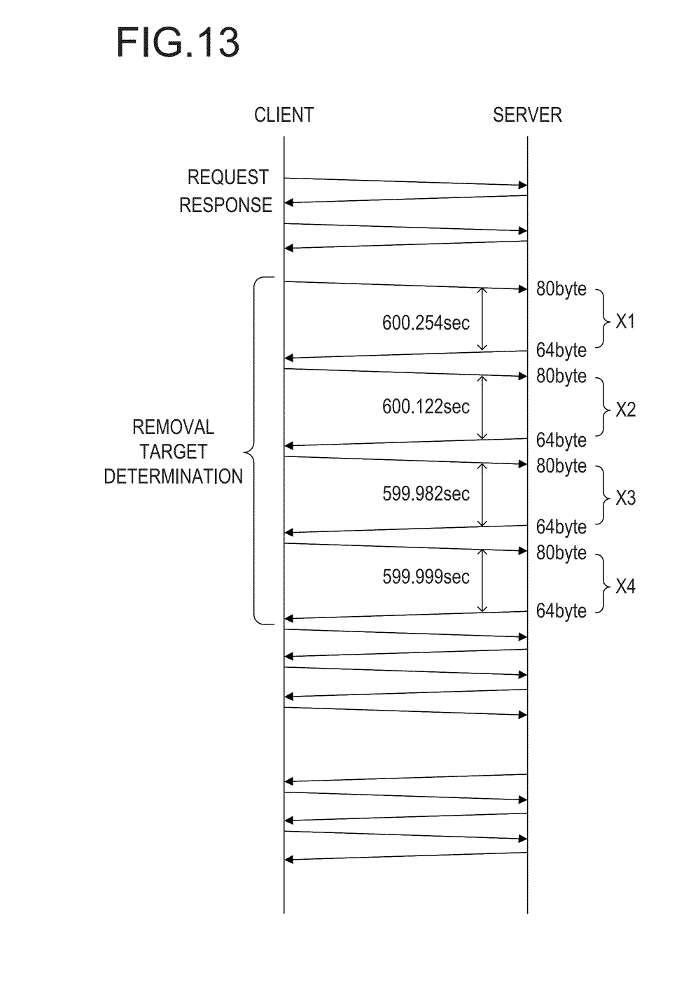

FIG. 13 is a sequence chart for explaining a process of extracting a removal condition. In FIG. 13, an exemplary communication sequence between the client and the server at the application layer is illustrated. In the example of FIG. 13, it is assumed that Δtₜₕ=10[sec], σₜₕ=0.5[sec], and t1=3. In this case, the response time of the pairs of the request and response messages X1, X2, X3, and X4 is equal to or greater than Δtₜₕ, and further, the pairs of the request and response messages satisfy all of the determination conditions (1), (2), (3), and (4). Accordingly, the pairs of the request and response messages X1, X2, X3, and X4 included in the same group Z and the number of pairs of the request and response messages included in the group Z is four (4) which is greater than the threshold value t1, i.e., 4>t1. Also, the standard deviation of the response time of the pairs of the request and response messages X1, X2, X3, and X4 is equal to or less than σₜₕ. Accordingly, in this case, the determination unit 34 extracts, as the removal condition, connection information of the connection of the pairs of the request and response messages X1, X2, X3, and X4, the request size of 80 bytes, and the response size of 64 bytes.

Then, the determination unit 34 stores the extracted removal condition in the to-be-removed information 43. In the to-be-removed information 43, the connection information and information indicating the sizes of the request message and the response message are stored in association with each other as the removal condition.

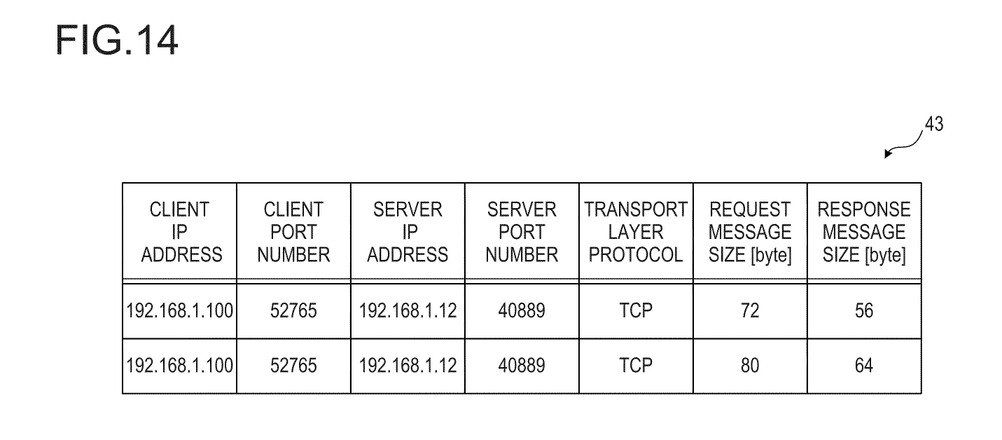

FIG. 14 is a table illustrating an exemplary configuration of the to-be-removed information 43. In FIG. 14, the to-be-removed information 43 includes data items for a “client IP address”, a “client port number”, a “server IP address”, a “server port number”, and a “transport layer protocol”. Further, the to-be-removed information 43 includes data items for a “request message size”, and a “response message size”. The data items are associated with each other for each record (row).

The “client IP address” is information indicating an IP address of the client terminal 21 which has transmitted the request. The “client port number” is information indicating a port number of the client terminal 21 which has transmitted the request. The “server IP address” is information indicating an IP address of the server which has transmitted the response. The “server port number” is information indicating a port number of the server which has transmitted the response. The “transport layer protocol” is information indicating a type of a transport layer protocol used in communication between the pairs of the request and response messages. The “request message size” is information indicating the size of the request message. The “response message size” is information indicating the size of the response message.

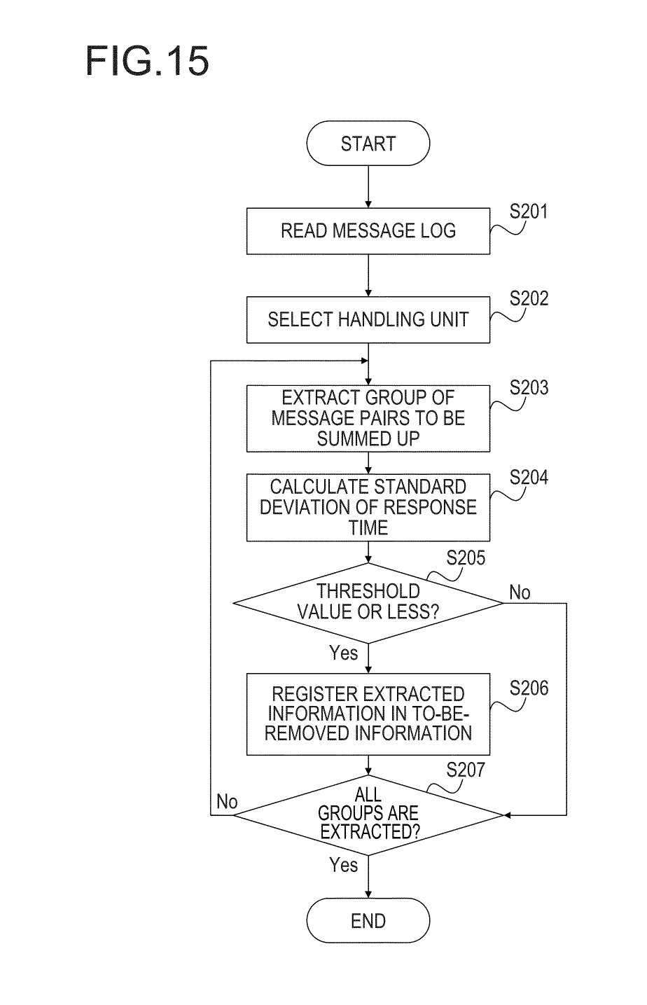

FIG. 15 is a flowchart illustrating an exemplary process of determining a removal target. In FIG. 15, first of all, the determination unit 34 reads the message log 41 (S201). The determination unit 34 reads all the records of the message log 41 in a batch.

Next, the determination unit 34 selects a handling unit (S202). That is, the determination unit 34 determines whether to select messages communicated in a single connection or messages communicated in plural connections as the handling unit in the determination condition (1). The determination unit 34 may select both the handling units simultaneously and perform the subsequent processing.

Next, the determination unit 34 extracts one of groups of pairs of the request and response messages among the message log 41 (S203). Specifically, the determination unit 34, first of all, identifies, in the message log 41, groups each including pairs of the request and response messages that satisfy the determination conditions described above among the records in which the “response time” is the predetermined threshold value Δtₜₕ or more. Then, the determination unit 34 extracts, from among the identified groups of pairs of the request and response messages, one group having pairs the number thereof is the predetermined threshold value t1 or more.

Next, the determination unit 34 calculates the standard deviation of the response times of the pairs of the request and response messages that are included in the extracted group (S204). Then, the determination unit 34 determines whether the calculated standard deviation is equal to or less than the predetermined threshold value σₜₕ (S205). When it is determined that the standard deviation is greater than the predetermined threshold value σₜₕ (“NO” at S205), the determination process goes to S207.

When it is determined that the standard deviation is equal to or less than the predetermined threshold value σₜₕ (“YES” at S205), the determination unit 34 stores the data item for identifying the handling unit, the size of the request message, and the size of the response message regarding the extracted group in the to-be-removed information 43 (S206). Specifically, the determination unit 34 prepares a new record in the to-be-removed information 43 and stores, in each data item of the prepared record, the value of the corresponding data item (the data item having the same name) of the record of the pairs of the request and response messages that are included in the extracted group. When the handling unit is the plural connections, the data item of the “client port number” of the to-be-removed information 43 is omitted.

Next, the determination unit 34 determines whether all the groups of pairs of the request and response messages are extracted at S203 (S207). When it is determined that some groups among the groups of pairs of the request and response messages are not yet extracted at S203 (“NO” at S207), the determination process goes back to S203 and the determination unit 34 extracts a group which is not yet extracted. When it is determined that all the groups of pairs of the request and response messages are extracted at S203 (“YES” at S207), the determination process is ended.

Next, descriptions will be made on a removal process (S3 of FIG. 6) performed by the removal unit 35. The removal unit 35 removes pairs of the request and response messages to be removed from the message log 41 based on the to-be-removed information 43.

Specifically, the removal unit 35 determines whether the pairs of the request and the response messages in the message log 41 satisfy any of the removal conditions in the to-be-removed information 43. The determination as to whether the removal condition is satisfied is made for each determination scope. The determination scope is any one of (A) server, (B) client, and (C) connection.

In a case of the (A) server, the removal unit 35 determines whether the following data items are identical to each other between the message log 41 and the to-be-removed information 43. The data items are the “server IP address”, the “server port number”, the “transport layer protocol”, the “request message size”, and the “response message size”. When all of these data items are identical to each other, the removal unit 35 determines that the pair of the request and response messages satisfies the removal condition in the to-be-removed information 43.

In a case of the (B) client, the removal unit 35 determines whether the following data items are identical to each other between the message log 41 and the to-be-removed information 43. The data items are the “client IP address”, the “server IP address”, the “server port number”, the “transport layer protocol”, the “request message size”, and the “response message size”. When all of these data items are identical to each other, the removal unit 35 determines that the pair of the request and response messages satisfies the removal condition in the to-be-removed information 43.

In a case of the (C) connection, the removal unit 35 determines whether the following data items are identical to each other between the message log 41 and the to-be-removed information 43. The data items are the “client IP address”, the “client port number”, the “server IP address”, the “server port number”, the “transport layer protocol”, the “request message size”, and the “response message size”. When all of these data items are identical to each other, the removal unit 35 determines that the pair of the request and response messages satisfies the removal condition in the to-be-removed information 43.

The removal unit 35 deletes the message determined to be satisfying the removal condition from the message log 41.

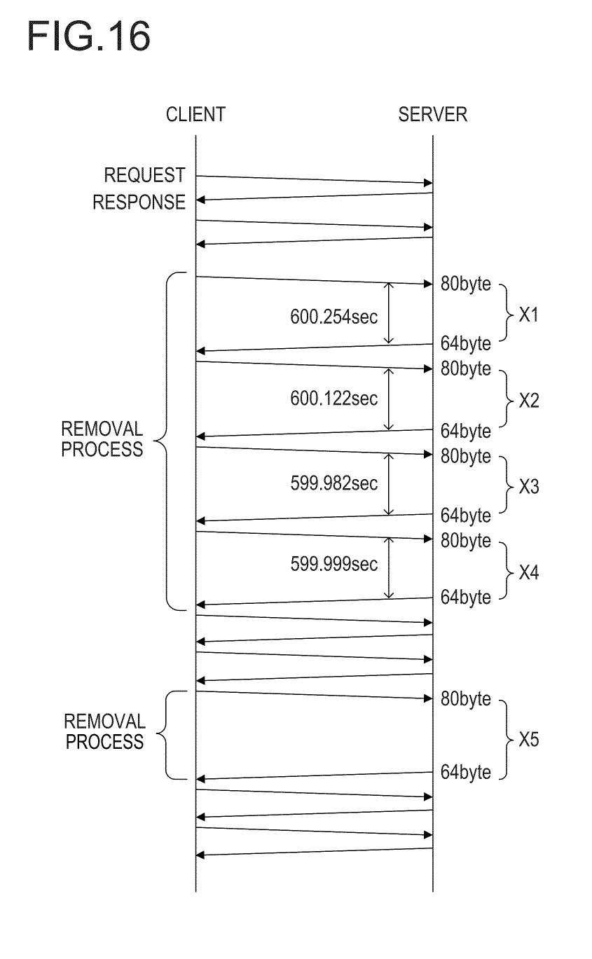

FIG. 16 is a sequence chart for explaining a process of removing a pair to be removed from the message log 41. FIG. 16 illustrates an example in which pairs of the request and response messages to be removed are deleted on the basis of the to-be-removed information 43 prepared in the example of FIG. 13. The “request message size” and the “response message size” of the removal condition prepared on the basis of the X1, X2, X3, and X4 in FIG. 13 are 80 bytes and 64 bytes, respectively. The communication sequence of FIG. 16 and FIG. 13 indicates the communication sequence in the same connection. Accordingly, in FIG. 16, it is determined that all the pairs of the request and response messages having the request size of 80 bytes and the response size of 64 bytes satisfy the removal condition. That is, it is determined that X1, X2, X3, X4, and X5 in FIG. 16 satisfy the removal condition.

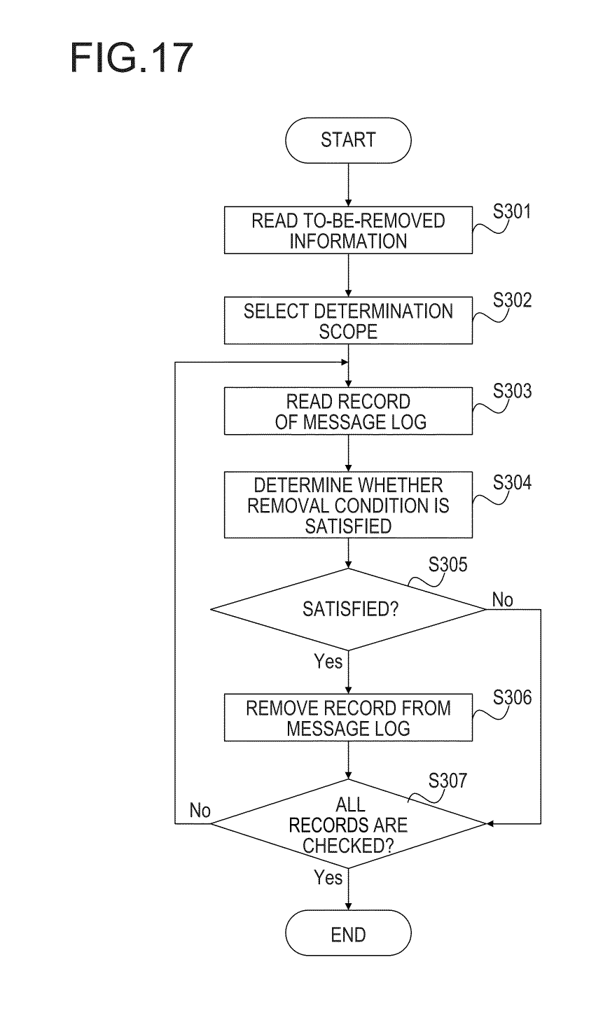

FIG. 17 is a flowchart illustrating an example of the removal process. In FIG. 17, the removal unit 35 reads the to-be-removed information 43 (S301). Next, the removal unit 35 selects a determination scope (S302). The determination scope is any one of (A), (B), and (C) described above.

Next, the removal unit 35 reads a record of the message log 41 (S303). Next, the removal unit 35 determines whether a pair of the request and response messages of the read record satisfies the removal condition (S304). The determination as to whether the removal condition is satisfied is made for the determination scope selected at S302.

When it is determined that the removal condition is not satisfied (“NO” at S305), the removal process goes to S307. When it is determined that the removal condition is satisfied (“YES” at S305), the removal unit 35 deletes the record read at S303 from the message log 41(S306).

Next, the removal unit 35 determines whether all the records of the message log 41 are read at S303 (S307). When it is determined that any one of the records of the message log 41 is not read (“NO” at S307), the removal process goes to S303 and the determination unit 34 reads the record which is not yet read. When it is determined that all the records of the message log 41 are read (“YES” at S307), the removal process is ended.

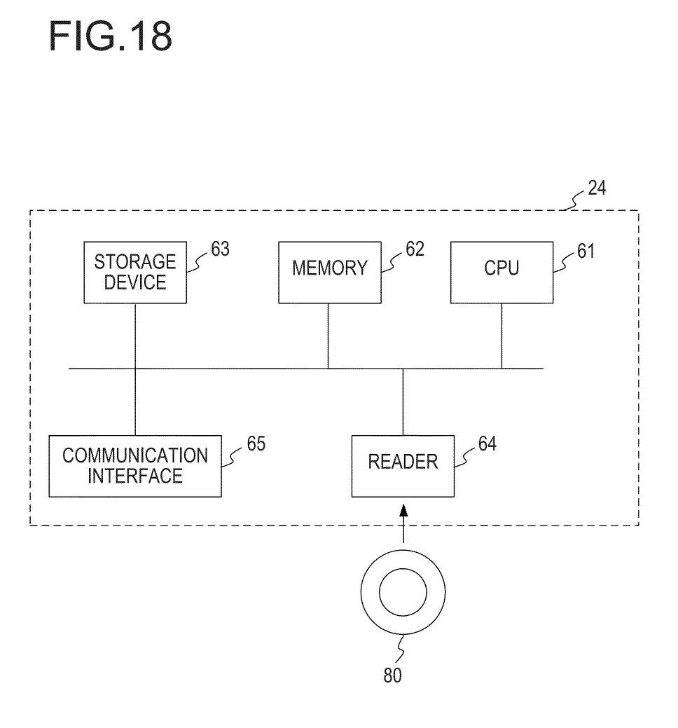

Next, descriptions will be made on a hardware configuration of the message log removal apparatus 24 according to the embodiment. FIG. 18 is a diagram illustrating an exemplary hardware configuration of the message log removal apparatus 24 according to the embodiment.

In FIG. 18, the message log removal apparatus 24 includes a central processing unit (CPU) 61, a memory 62, a storage device 63, a reader 64, and a communication interface 65. The CPU 61, the memory 62, the storage device 63, the reader 64, and the communication interface 65 are connected with each other via a bus or the like.

The CPU 61 executes, using the memory 62 a program in which a series of sequences of the flowchart described above are described, so as to provide a portion or all of the functions of the acquisition unit 32, the analysis unit 33, the determination unit 34, and the removal unit 35.

The memory 62 is, for example, a semiconductor memory and includes a random access memory (RAM) area and a read-only memory (ROM) area. The memory 62 may be a semiconductor memory such as a flash memory. The memory 62 provides a portion or all of the functions of the storage unit 31. The threshold values used in the processes described above are stored in the memory 62. All of the threshold values may be different from each other and otherwise, some or all of the threshold values may be the same.

The storage device 63 is, for example, a hard disk. The storage device 63 may be a semiconductor memory such as a flash memory. The storage device 63 may be an external recording device. The storage device 63 may provide a portion or all of the functions of the storage unit 31

The reader 64 accesses a removable storage medium 80 in accordance with an instruction from the CPU 61. The removable storage medium 80 is implemented by, for example, a semiconductor device such as a universal serial bus (USB) memory or the like, a medium such as a magnetic disk or the like for which the information is input/output by magnetic action, and a medium such as a compact disc ROM (CD-ROM) or a digital versatile disc (DVD) for which the information is input/output by optical action. The reader 64 is not necessarily included in the message removal device.

The communication interface 65 communicates with the relay device 23 through, for example, a communication network in accordance with an instruction from the CPU 61.

The program according to the embodiment is provided for the message log removal apparatus 24 in, for example, the following form.

Being preinstalled in the storage device 63.

Being provided by the removable storage medium 80.

Being provided from a program server (not illustrated) through the communication interface 65.

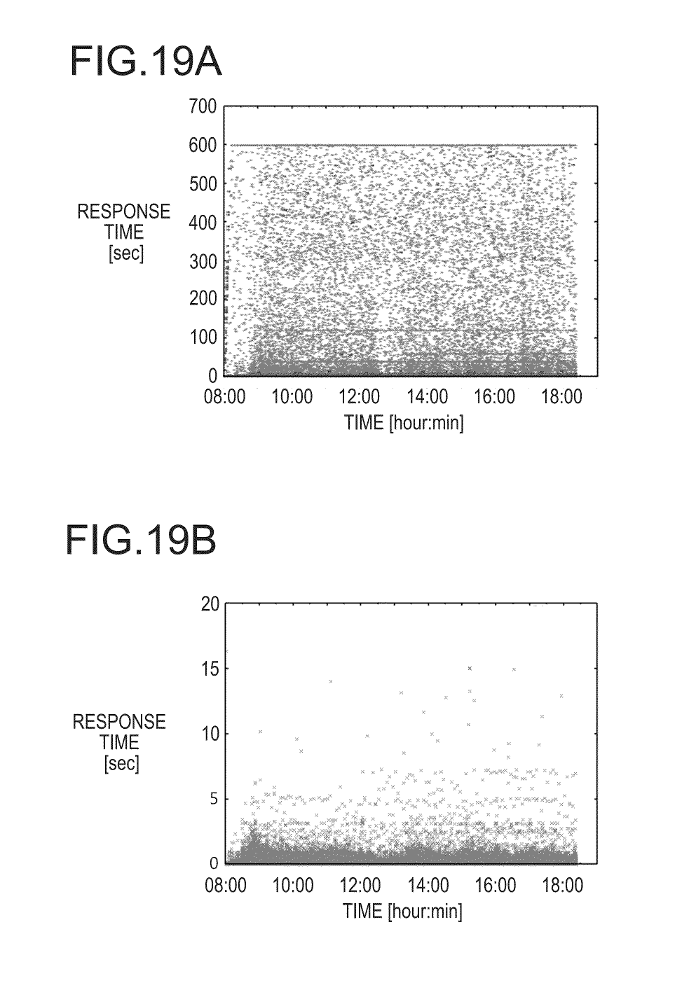

FIG. 19A and FIG. 19B are diagrams illustrating respective results of response time calculation in a comparative example and the embodiment. FIG. 19A is an example of a result of response time calculation in the comparative example. FIG. 19B is an example of response time calculation in the embodiment.

In FIG. 19A, a value of a waiting time of a server is actually plotted as a response time. In FIG. 19B, a value of a waiting time of a server is removed. As described above, according to the embodiment, an erroneous detection where an increase of the server waiting time is erroneously detected as a response delay may be suppressed. Further, according to the embodiment, a missing of an actual response delay by being buried in the server waiting time may be suppressed.

The message log removal apparatus 24 according to the embodiment may be implemented in hardware. Alternatively, the message log removal apparatus 24 according to the embodiment may be implemented in a combination of software and hardware.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A message log removal apparatus, comprising:
a storage device; and
a processor configured to
acquire data packets communicated between communication devices,
prepare a packet record for each of the data packets, the packet record including a reception time, a packet size, destination information, and source information, the reception time indicating a time at which each of the data packets is received, the packet size indicating a size of each of the data packets, the destination information indicating a transmission destination of each of the data packets, the source information indicating a transmission source of each of the data packets,
store the prepared packet records in the storage device,
prepare message records on basis of the packet records stored in the storage device, each of the message records corresponding to a pair of a request message and a response message, each of the message records including a first reception time, a second reception time, a first size indicating a size of the request message, a second size indicating a size of the response message, first source information indicating a first transmission source, and first destination information indicating a first transmission destination, the first reception time indicating a time at which the request message is received, the second reception time indicating a time at which the response message is received, the request message being constructed of first data packets transmitted from the first transmission source to the first transmission destination, the response message being constructed of second data packets transmitted from the first transmission destination to the first transmission source, the second data packets being received after the first data packets,
store the prepared message records in the storage device, and
remove a first message record from among the message records stored in the storage device on basis of the first size, the second size, the first source information, and the first destination information included in the first message record.

2. The message log removal apparatus according to claim 1, wherein the processor is configured to
calculate a time difference for each of second message records, the time difference being a difference between the first reception time and the second reception time included in each of the second message records, each of the second message records including the first source information identical to the first source information included in the first message record and the first destination information identical to the first destination information included in the first message record, and
remove the first message record on basis of the first size and the second size included in each of the second message records and the time difference calculated for each of the second message records.

3. The message log removal apparatus according to claim 2, wherein
the time difference calculated for each of the second message records is greater than a first threshold value,
differences between the first sizes included in the second message records are less than a second threshold value,
differences between the second sizes included in the second message records are less than a third threshold value,
a standard deviation of the time differences calculated for the second message records is less than a fourth threshold value, and
a number of the second message records is greater than a fifth threshold value.

4. A message log removal method, comprising:
acquiring, by a computer, data packets communicated between communication devices;
preparing a packet record for each of the data packets, the packet record including a reception time, a packet size, destination information, and source information, the reception time indicating a time at which each of the data packets is received, the packet size indicating a size of each of the data packets, the destination information indicating a transmission destination of each of the data packets, the source information indicating a transmission source of each of the data packets;
storing the prepared packet records in a storage device;
preparing message records on basis of the packet records stored in the storage device, each of the message records corresponding to a pair of a request message and a response message, each of the message records including a first reception time, a second reception time, a first size indicating a size of the request message, a second size indicating a size of the response message, first source information indicating a first transmission source, and first destination information indicating a first transmission destination, the first reception time indicating a time at which the request message is received, the second reception time indicating a time at which the response message is received, the request message being constructed of first data packets transmitted from the first transmission source to the first transmission destination, the response message being constructed of second data packets transmitted from the first transmission destination to the first transmission source, the second data packets being received after the first data packets;
storing the prepared message records in the storage device; and
removing a first message record from among the message records stored in the storage device on basis of the first size, the second size, the first source information, and the first destination information included in the first message record.

5. A computer-readable recording medium having stored therein a program that causes a computer to execute a process, the process comprising:
acquiring, data packets communicated between communication devices;
preparing a packet record for each of the data packets, the packet record including a reception time, a packet size, destination information, and source information, the reception time indicating a time at which each of the data packets is received, the packet size indicating a size of each of the data packets, the destination information indicating a transmission destination of each of the data packets, the source information indicating a transmission source of each of the data packets;
storing the prepared packet records in a storage device;
preparing message records on basis of the packet records stored in the storage device, each of the message records corresponding to a pair of a request message and a response message, each of the message records including a first reception time, a second reception time, a first size indicating a size of the request message, a second size indicating a size of the response message, first source information indicating a first transmission source, and first destination information indicating a first transmission destination, the first reception time indicating a time at which the request message is received, the second reception time indicating a time at which the response message is received, the request message being constructed of first data packets transmitted from the first transmission source to the first transmission destination, the response message being constructed of second data packets transmitted from the first transmission destination to the first transmission source, the second data packets being received after the first data packets;
storing the prepared message records in the storage device; and
removing a first message record from among the message records stored in the storage device on basis of the first size, the second size, the first source information, and the first destination information included in the first message record.
